(19) United States
(12) Patent Application Publication
(10) Pub. No.: US 2016/0051905 A1
(43) Pub. Date: Feb. 25, 2016

(54) Water Distiller Apparatus

(71) Applicant: Lucas R. Baker, New London, CT (US)

(72) Inventor: Lucas R. Baker, New London, CT (US)

(21) Appl. No.: 14/829,974

(22) Filed: Aug. 19, 2015

Related U.S. Application Data
(60) Provisional application No. 62/039,671, filed on Aug. 20, 2014.

(51) Int. Cl. B01D 3/02

(52) U.S. Cl. CPC B01D 3/02

(57) ABSTRACT

A water distiller apparatus includes a boiler, a first condenser unit, a connector tube, a second condenser unit and an exhaust chimney. The boiler that contains unpurified water is exposed to an external heat source so that water vapor can be produced and condensed within the first condenser unit. Then the apparatus is able to discharge clean liquid water into a collection vessel. The excess water vapor is then discharged and condensed within the connector tube and the second condenser unit, where the apparatus once again discharges clean liquid water into another collection vessel. Then the remaining water vapor is discharged into the exhaust chimney as the apparatus creates a third collection point for clean liquid water at the end of the exhaust chimney as cooling fins of the exhaust chimney cool down water vapor into clean liquid water.

The current application claims a priority to the U.S. Provisional Patent application Ser. No. 62/039,671 filed on Aug. 20, 2014.

### FIELD OF THE INVENTION

The present invention relates generally to a portable apparatus of producing drinkable water. More specifically, the present invention is provides a portable apparatus that purified water from any water source to attain potable water.

### BACKGROUND OF THE INVENTION

Access to clean water is, unfortunately, not ubiquitous. While developed countries have the resources and infrastructure to supply all of their citizens (or at least the vast majority) with clean water, many developing countries struggle to do the same. Additionally, even in developed countries persons may find themselves in situations where access to potable water is unavailable; this may be planned, such as during a camping trip, or unplanned, such as during a catastrophe. It is therefore desirable to provide a means of sanitizing water for human consumption.

In recognition of the aforementioned problem, a number of methods and apparatuses have been created for the express purpose of treating water when potable water is not accessible. While many of these methods and apparatuses are adequate for water purification, they are not without their drawbacks. For example, some solutions lack in efficiency, wasting a lot of water during the purification process; such solutions are not viable in regions with limited access to water. Other solutions, though efficient, are bulky and effectively immobile; it is difficult to move them rapidly in response to events that require temporary water purification, such as natural disasters. Another limitation encountered with existing solutions is the in ability to sanitize significant amounts of water; some apparatuses are, due to their mechanism of action, simply incapable treating large amounts of water in a timely manner. And while there are solutions which are efficient, compact, and effective, they tend to be advanced apparatuses which require high costs materials and construction; the resulting product, while desirable, is simply too cost prohibitive for developing regions.

It is therefore an object of the present invention to provide a two stage distiller which can be constructed from simple and inexpensive materials. The present invention is compact, easy to assemble, and suitable for use in a variety of environments. The present invention thus addresses the shortcomings of the prior art.

### BRIEF DESCRIPTION OF THE DRAWINGS

FIG. 1 is a perspective view of the present invention.

FIG. 2 is a front view of the present invention, wherein the broken lines illustrates the inside surface of the present invention.

FIG. 3 is a perspective view of the boiler of the present invention.

FIG. 4 is a front view of the boiler of the present invention, wherein the broken lines illustrates the inside surface of the boiler.

FIG. 5 is a bottom perspective view of the first condenser unit of the present invention.

FIG. 6 is a side view of the first condenser unit of the present invention, showing the plane upon which a cross sectional view is taken shown in FIG. 7.

FIG. 7 is a cross section view of the first condenser unit of the present invention taken along line A-A of FIG. 6.

FIG. 8 is a perspective view of the second condenser unit of the present invention.

FIG. 9 is a front view of the second condenser unit of the present invention, wherein the broken lines illustrates the inside surface of the second condenser unit.

FIG. 10 is a perspective view of the exhaust chimney of the present invention.

FIG. 11 is a side view of the exhaust chimney of the present invention.

### DETAIL DESCRIPTIONS OF THE INVENTION

All illustrations of the drawings are for the purpose of describing selected versions of the present invention and are not intended to limit the scope of the present invention.

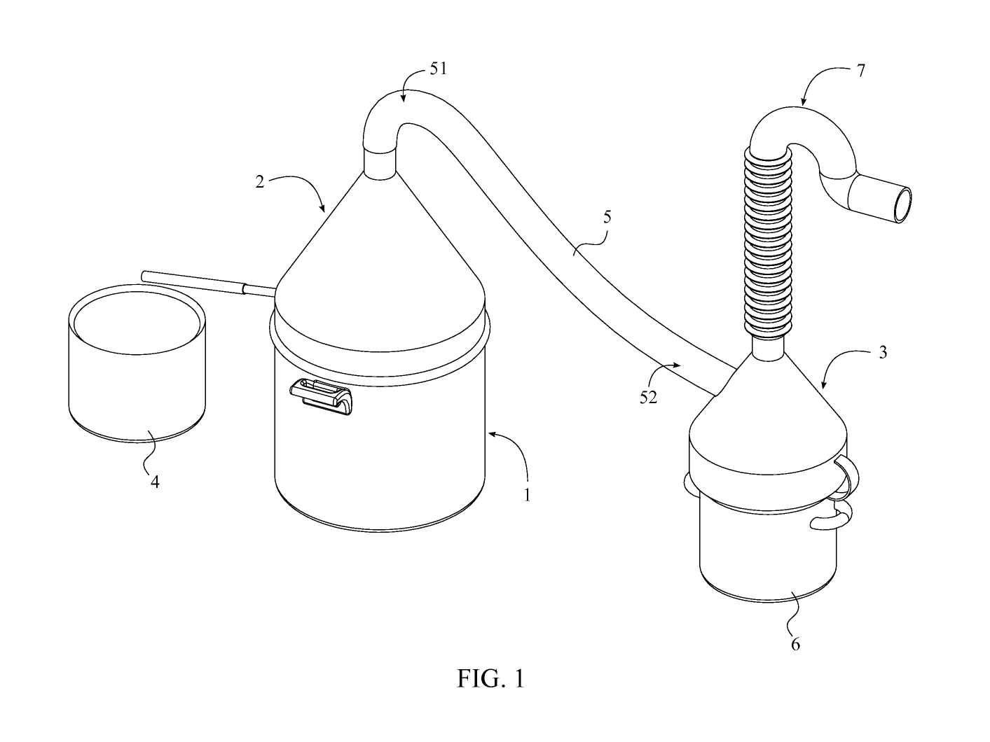

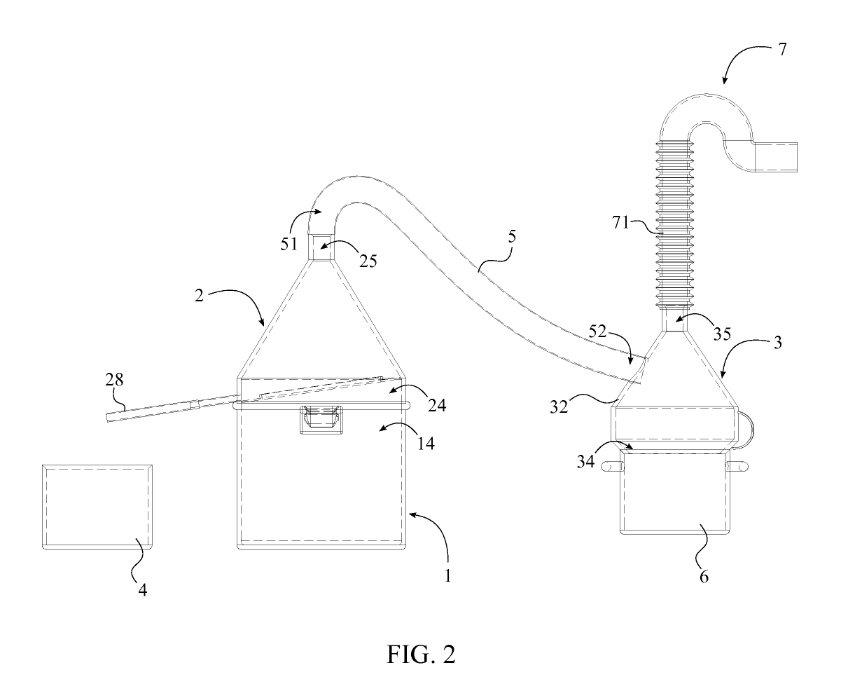

The present invention is a potable water distiller apparatus that purifies contaminated water into potable water. The present invention provides an efficient and economical apparatus as multiple exit points are provided within the apparatus to discharge clean water in a relatively rapid manner and sufficient quantities. In reference to FIG. 1 and FIG. 2, the present invention comprises a boiler 1, a first condenser unit 2, a connector tube 5, a second condenser unit 3, and an exhaust chimney 7. As for the general configuration of the present invention, the first condenser unit 2 is hermetically connected atop the boiler 1 as the boiler 1 is placed on an external heat source to boil contaminated water that is placed within the boiler 1. The second condenser unit 3 is hermetically connected with the first condenser unit 2 through the connector tube 5 while the exhaust chimney 7 is hermetically connected atop the second condenser unit 3. The boiler 1 is in fluid communication with the exhaust chimney 7 through the first condenser unit 2, the connector tube 5, and the second condenser unit 3. As a result of the hermetic connection points, the in fluid communications points, and the components configuration of the present invention, water vapor from contaminated water is able to travel and condensed through the present invention while creating multiple exit points for clean water.

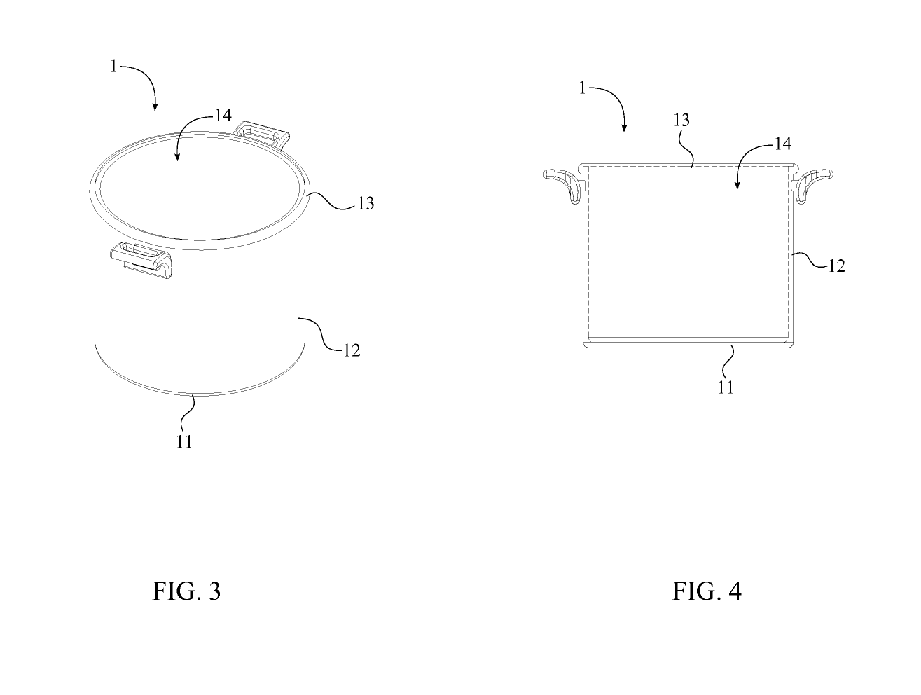

The boiler 1 is utilized to hold contaminated water and to heat contaminated water via the external heat source. Depending on the environment that the present invention is presented with, the external heat source can be an electrical heat energy source, natural gas heat energy source, firewood heat energy source, or any other types of similar heat energy sources that can provide sufficient amount of heat energy to boil contaminated water. The boiler 1 is preferably made from aluminum or any other materials that have a higher thermal conductivity so that contaminated water can be quickly boiled. In reference to FIG. 3-4, the boiler 1 comprises a base 11, a lateral wall 12, a brim 13, and a container opening 14. More specifically, the lateral wall 12 is perimetrically connected around the base 11 while the brim 13 is perimetrically positioned around the lateral wall 12, opposite of the base 11. The container opening 14, which retains contaminated water, is delineated by the brim 13, the lateral wall 12, and the base 11. When the external heat source provides heat energy to the boiler 1, contaminated water within the boiler 1 reaches to the boiling point where the liquid water transforms into water vapor. The created water vapor within the boiler 1 is then utilized throughout the present invention to obtain clean liquid water by implementing the condensation process. The boiler 1 may optionally comprise a plurality of foldable or detachable legs that connects with the base 11 so that the boiler 1 can be placed above the external heat source by utilizing the plurality of foldable or detachable legs when necessary.

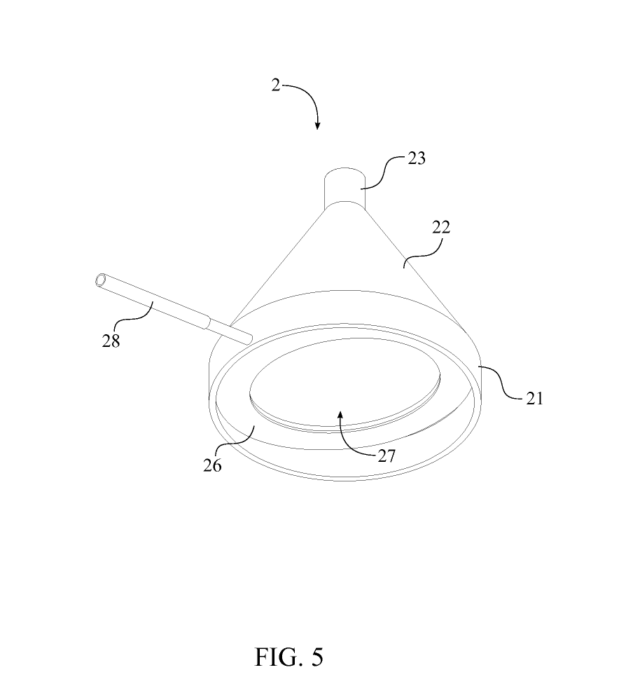

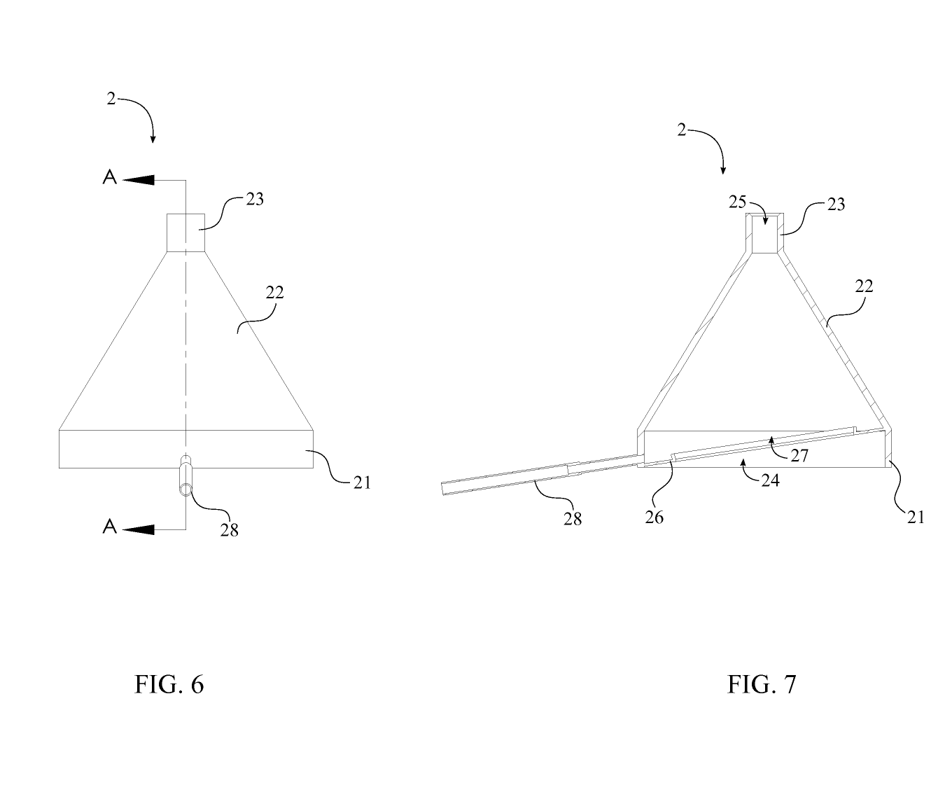

The first condenser unit 2 transforms water vapor from the boiler 1 to clean liquid water so that clean liquid water can be collected from the present invention. The first condenser unit 2 is preferably made from aluminum or any other materials that have a higher thermal conductivity to maximize the efficiency of the condensation process. The first condenser unit 2 functions as the first collection point for clean liquid water and comprises a first bottom section 21, at least one first middle section 22, a first spout section 23, a first bottom opening 24, a first top opening 25, a collector lip 26, and a collection port 28. In reference to FIG. 5-7, the at least one first middle section 22 is perimetrically connected with the first bottom section 21 as the first spout section 23 is perimetrically connected with the at least one first middle section 22, opposite of the first bottom section 21. The first bottom section 21 is shaped to match the shape of the brim 13 so that the first bottom section 21 is able to create an airtight connection between the boiler 1 and the first condenser unit 2. The first bottom opening 24 is delineated by the first bottom section 21 while the first top opening 25 is delineated by the first spout section 23. Additionally, the first bottom opening 24 is in fluid communication with the container opening 14 so that water vapor from the boiler 1 can be discharged into the first condenser unit 2. The first bottom opening 24 and the first top opening 25 are in fluid communication with the each other through the first bottom section 21, the at least one first middle section 22, and the first spout section 23 as the first bottom section 21, the at least one first middle section 22, and the first spout section 23 create a hollow body for the first condenser unit 2.

The condensation process is mainly carried out through the at least one first middle section 22 as clean liquid water is collected through the collector lip 26 and the collection port 28. More specifically, the collector lip 26 that comprises a central opening 27 is internally positioned with the first bottom section 21 and angularly connected within the first bottom section 21. The collection port 28 is traversed into the collector lip 26 through the first bottom section 21 in such a way that the collector lip 26 is in fluid communication with the collection port 28. Since the central opening 27 traverses through the collector lip 26, water vapor is able to efficiently travel from the first bottom section 21 to the first spout section 23 where the condensation process transforms water vapor into clean liquid water. Once clean liquid water is produced within the first condenser unit 2, clean liquid water is collected by the collector lip 26 and discharges into a first collection vessel 4 through the collection port 28.

In reference to FIG. 5-7 that illustrates the preferred embodiment of the present invention, the at least one first middle section 22 has an annular body that is angled or tapered from the first bottom section 21 to the first spout section 23. The first bottom section 21 and the first spout section 23 have straight or vertical lateral wall; however, the diameter of the first bottom section 21 is larger than the diameter on the first spout section 23 so that escaping water vapor can be funneled into the connector tube 5. Additionally, the angled lateral wall of the at least one first middle section 22 allows clean liquid water to easily drip down into the collector lip 26 along an inner surface of the first condenser unit 2.

In reference to FIG. 1-2, the connector tube 5 creates a fluid communication with the first condenser unit 2 and the second condenser unit 3 while preforming condensation process within. More specifically, a first end 51 of the connector tube 5 is hermetically connected with the first spout section 23 in such a way that the first end 51 is in fluid communication with the first top opening 25. As a result, any excess water vapor from the first condenser unit 2 can be discharged into the connector tube 5 through the first top opening 25. Water vapor within the connector tube 5 is also able to go through the condensation process as the connector tube 5 is preferably made from materials that have the characteristic of high thermal conductivity, such as aluminum. A second end 52 of the connector tube 5 is hermetically connected with at least one second middle section 32 of the second condenser unit 3 so that the second end 52 can be in fluid communication with the second condenser unit 3. As a result, any excess water vapor from the connector tube 5 is able to discharge into the second condenser unit 3. Since some of water vapor transforms into clean liquid water within the connector tube 5, the transformed clean liquid water is also able to drip down from the connector tube 5 and into the second condenser unit 3.

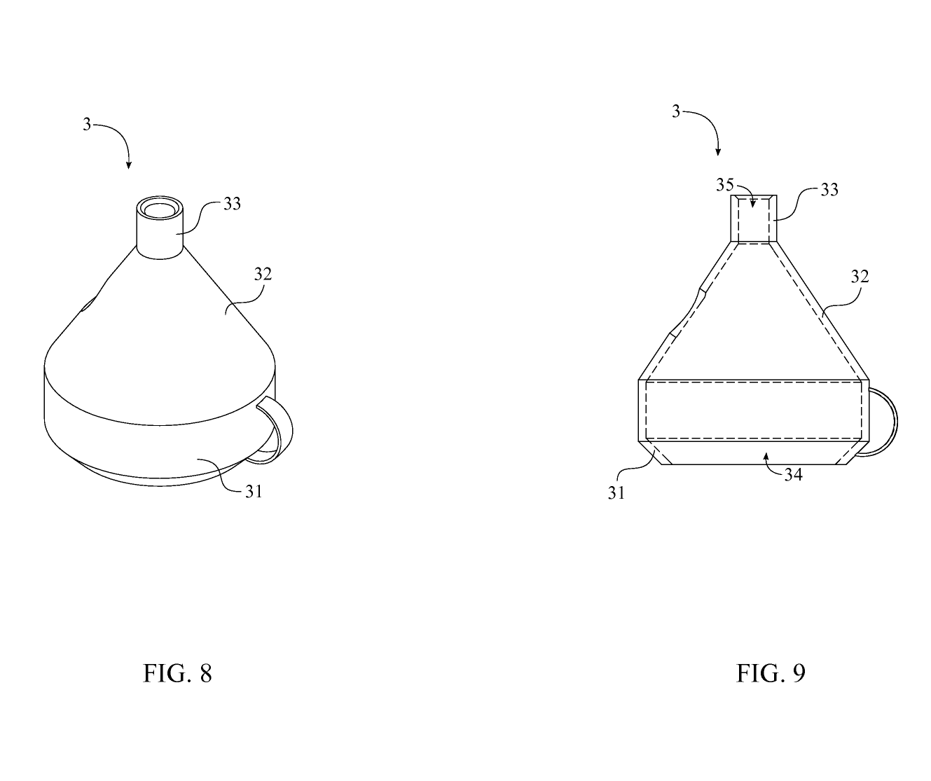

The second condenser unit 3 transforms water vapor from the connector tube 5 to clean liquid water so that additional amount of clean liquid water can be collected from the present invention. The second condenser unit 3 is preferably made from aluminum or any other materials that have a higher thermal conductivity to maximize the efficiency of the condensation process. The second condenser unit 3 functions as the second collection point for clean liquid water and comprises a second bottom section 31, at least one second middle section 32, a second spout section 33, a second bottom opening 34, and a second top opening 35. In reference to FIG. 8-9, the at least one second middle section 32 is perimetrically connected with the second bottom section 31 as the second spout section 33 is perimetrically connected with the at least one second middle section 32, opposite of the second bottom section 31. The second bottom section 31 is shaped to match the shape of a second collection vessel 6 so that the second bottom section 31 is able to create an airtight connection between the second collection vessel 6 and the second condenser unit 3. The second bottom opening 34 is delineated by the second bottom section 31 while the second top opening 35 is delineated by the second spout section 33. Additionally, the second bottom opening 34 is in fluid communication with the second collection vessel 6 so that clean liquid water from the connector tube 5 can be collected within the second collection vessel 6. The second bottom opening 34 and the second top opening 35 are in fluid communication with the each other through the second bottom section 31, the at least one second middle section 32, and the second spout section 33 as the second bottom section 31, the at least one second middle section 32, and the second spout section 33 create a hollow body for the second condenser unit 3.

The condensation process is mainly carried out through the at least one second middle section 32 and the second spout section 33 as water vapor from the connector tube 5 travels into the exhaust chimney 7. As a result, clean liquid water from the second condenser unit 3 can be collected within the second collection vessel 6 as clean liquid water is discharged into the second collection vessel 6 through the inner surface of the second condenser unit 3. The second top opening 35 is in fluid communication a vertical portion 71 of exhaust chimney 7 so that any excess water vapor that exists the second condenser unit 3 can be discharged out of the present invention.

In reference to FIG. 8-9 that illustrates the preferred embodiment of the present invention, the at least one second middle section 32 has an annular body that is angled or tapered from the second bottom section 31 to the second spout section 33. The second bottom section 31 and the second spout section 33 have straight or vertical lateral wall; however, the diameter of the second bottom section 31 is larger than the diameter on the second spout section 33 so that the escaping water vapor can be funneled into the exhaust chimney 7. Additionally, the angled lateral wall of the at least one second middle section 32 allows clean liquid water to easily drip down into the second collection vessel 6 along the inner surface of the second condenser unit 3.

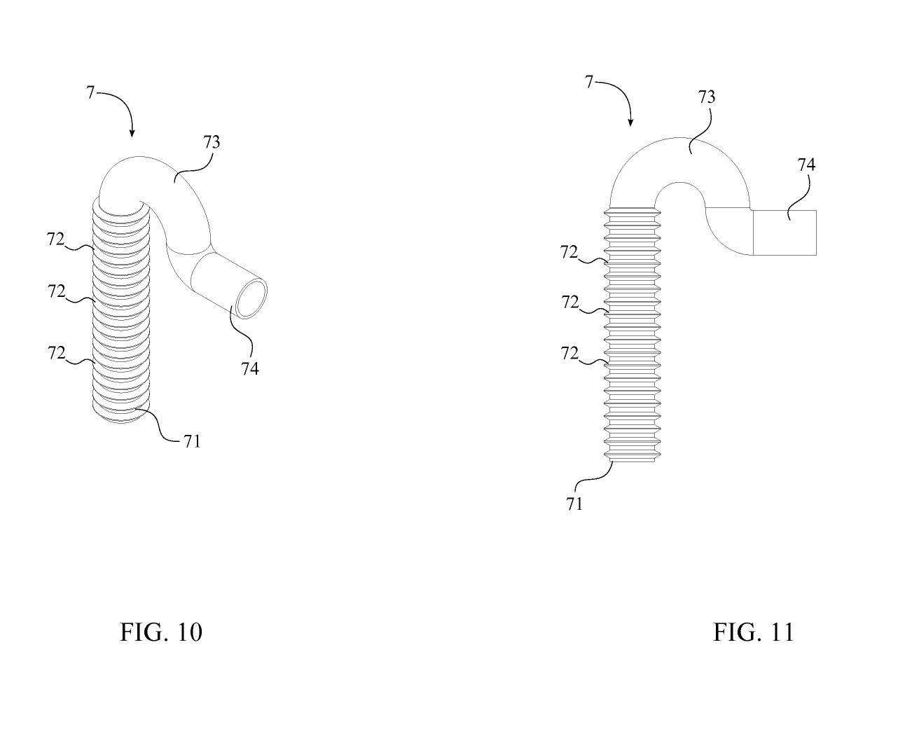

The exhaust chimney 7 emits excess water vapor from the present invention and functions as the third collection point for clean liquid water. In reference to FIG. 10-11, the exhaust chimney 7 comprises a vertical portion 71, a U-shaped portion 73, a horizontal portion 74, and a plurality of cooling fins 72. More specifically, the U-shaped portion 73 is in fluid communication with the vertical portion 71 as the horizontal portion 74 is in fluid communication with the U-shaped portion 73 opposite of the vertical portion 71. Configuration of these different portions of the exhaust chimney 7 forms the basic structure where the U-shaped portion 73 is positioned upside down to accept the vertical portion 71 from one end and the horizontal portion 74 from the opposite end. The plurality of cooling fins 72 is extended along the vertical portion 71 to further cool down water vapor that exists the present invention. As a result, clean liquid water from the exhaust chimney 7 can be discharged into a third collection vessel through the horizontal portion 74. The exhaust chimney 7 is preferably made from aluminum or any other materials that have the characteristic of higher thermal conductivity to maximize the efficiency of the condensation process.

Although the invention has been explained in relation to its preferred embodiment, it is to be understood that many other possible modifications and variations can be made without departing from the spirit and scope of the invention as hereinafter claimed.

What is claimed is:

1. A water distiller apparatus comprises:
a boiler;
a first condenser unit;
a connector tube;
a second condenser unit;
an exhaust chimney;
the first condenser unit comprises a first bottom section, at least one first middle section, a first spout section, a first bottom opening, a first top opening, a collector lip, and a collection port;
the second condenser unit comprises a second bottom section, at least one second middle section, a second spout section, a second bottom opening, a second top opening;
the first condenser unit being hermetically connected atop the boiler;
the second condenser unit being hermetically connected with the first condenser unit through the connector tube;
the exhaust chimney being hermetically connected atop the second condenser unit; and
the boiler being in fluid communication with the exhaust chimney through the first condenser unit, the connector tube, and the second condenser unit.

2. The water distiller apparatus as claimed in claim 1 comprises:
the boiler comprises a base, a lateral wall, a brim, and a container opening;
the lateral wall being perimetrically connected around the base;
the brim being perimetrically positioned around the lateral wall, opposite of the base; and
the container opening being delineated by the brim, the lateral wall, and the base.

3. The water distiller apparatus as claimed in claim 1 comprises:
the at least one first middle section being perimetrically connected with the first bottom section;
the first spout section being perimetrically connected with the at least one first middle section, opposite of the first bottom section;
the first bottom opening being delineated by the first bottom section;
the first top opening being delineated by the first spout section;
the first bottom opening and the first top opening being in fluid communication with the each other through the first bottom section, the at least one first middle section, and the first spout section;
the collector lip being internally positioned with the first bottom section;
the collector lip being angularly connected within the first bottom section;
the collection port traversing into the collector lip through the first bottom section; and
the collector lip being in fluid communication a first collection vessel through the collection port.

4. The water distiller apparatus as claimed in claim 3 comprises:
the collector lip comprises a central opening; and
the central opening traversing through the collector lip.

5. The water distiller apparatus as claimed in claim 1 comprises:
the at least one second middle section being perimetrically connected with the second bottom section;
the second spout section being perimetrically connected with the at least one second middle section, opposite of the second bottom section;
the second bottom opening being delineated by the second bottom section;
the second top opening being delineated by the second spout section; and
the second bottom opening and the second top opening being in fluid communication with the each other through the second bottom section, the at least one second middle section, and the second spout section.

6. The water distiller apparatus as claimed in claim 1 comprises:
the exhaust chimney comprises a vertical portion, a U-shaped portion, a horizontal portion, and a plurality of cooling fins;
the U-shaped portion being in fluid communication with the vertical portion;
the horizontal portion being in fluid communication with the U-shaped portion opposite of the vertical portion; and
the plurality of cooling fins being extended along the vertical portion.

7. The water distiller apparatus as claimed in claim 1 comprises:
a first end of the connector tube being hermetically connected with the first spout section; and
a second end of the connector tube being hermetically connected with the at least one second middle section.

8. The water distiller apparatus as claimed in claim 1 comprises:
a container opening of the boiler being in fluid communication with the first bottom opening;
the first top opening being in fluid communication with a first end of the connector tube;
a second end of the connector tube being in fluid communication with the at least one second middle section;
the second bottom opening being in fluid communication a second collection vessel; and
the second top opening being in fluid communication a vertical portion of exhaust chimney.

9. A water distiller apparatus comprises:
a boiler;
a first condenser unit;
a connector tube;
a second condenser unit;
an exhaust chimney;
the first condenser unit comprises a first bottom section, at least one first middle section, a first spout section, a first bottom opening, a first top opening, a collector lip, a collection port, and a central opening;
the second condenser unit comprises a second bottom section, at least one second middle section, a second spout section, a second bottom opening, a second top opening;
the at least one first middle section being perimetrically connected with the first bottom section;
the first spout section being perimetrically connected with the at least one first middle section, opposite of the first bottom section;
the first bottom opening being delineated by the first bottom section;
the first top opening being delineated by the first spout section;
the first bottom opening and the first top opening being in fluid communication with the each other through the first bottom section, the at least one first middle section, and the first spout section;
the collector lip being internally positioned with the first bottom section;
the collector lip being angularly connected within the first bottom section;
the collection port traversing into the collector lip through the first bottom section;
the collector lip being in fluid communication a first collection vessel through the collection port;
the central opening traversing through the collector lip;
the first condenser unit being hermetically connected atop the boiler;
the second condenser unit being hermetically connected with the first condenser unit through the connector tube;
the exhaust chimney being hermetically connected atop the second condenser unit; and
the boiler being in fluid communication with the exhaust chimney through the first condenser unit, the connector tube, and the second condenser unit.

10. The water distiller apparatus as claimed in claim 9 comprises:
the boiler comprises a base, a lateral wall, a brim, and a container opening;
the lateral wall being perimetrically connected around the base;
the brim being perimetrically positioned around the lateral wall, opposite of the base; and
the container opening being delineated by the brim, the lateral wall, and the base.

11. The water distiller apparatus as claimed in claim 9 comprises:
the at least one first middle section being perimetrically connected with the first bottom section;
the first spout section being perimetrically connected with the at least one first middle section, opposite of the first bottom section;
the first bottom opening being delineated by the first bottom section;
the first top opening being delineated by the first spout section;
the first bottom opening and the first top opening being in fluid communication with the each other through the first bottom section, the at least one first middle section, and the first spout section;
the collector lip being internally positioned with the first bottom section;
the collector lip being angularly connected within the first bottom section;
the collection port traversing into the collector lip through the first bottom section;
the collector lip being in fluid communication a first collection vessel through the collection port;
the collector lip comprises a central opening; and
the central opening traversing through the collector lip.

12. The water distiller apparatus as claimed in claim 9 comprises:
the at least one second middle section being perimetrically connected with the second bottom section;
the second spout section being perimetrically connected with the at least one second middle section, opposite of the second bottom section;
the second bottom opening being delineated by the second bottom section;
the second top opening being delineated by the second spout section; and
the second bottom opening and the second top opening being in fluid communication with the each other through the second bottom section, the at least one second middle section, and the second spout section.

13. The water distiller apparatus as claimed in claim 9 comprises:
the exhaust chimney comprises a vertical portion, a U-shaped portion, a horizontal portion, and a plurality of cooling fins;
the U-shaped portion being in fluid communication with the vertical portion;
the horizontal portion being in fluid communication with the U-shaped portion opposite of the vertical portion; and
the plurality of cooling fins being extended along the vertical portion.

14. The water distiller apparatus as claimed in claim 9 comprises:
a container opening of the boiler being in fluid communication with the first bottom opening;
a first end of the connector tube being hermetically connected with the first spout section;
the first top opening being in fluid communication with the first end of the connector tube;
a second end of the connector tube being hermetically connected with the at least one second middle section;
the second end of the connector tube being in fluid communication with the at least one second middle section;
the second bottom opening being in fluid communication a second collection vessel; and
the second top opening being in fluid communication a vertical portion of exhaust chimney.

15. A water distiller apparatus comprises:
a boiler;
a first condenser unit;
a connector tube;
a second condenser unit;
an exhaust chimney;
the first condenser unit comprises a first bottom section, at least one first middle section, a first spout section, a first bottom opening, a first top opening, a collector lip, a collection port, and a central opening;
the second condenser unit comprises a second bottom section, at least one second middle section, a second spout section, a second bottom opening, a second top opening;
the at least one first middle section being perimetrically connected with the first bottom section;
the first spout section being perimetrically connected with the at least one first middle section, opposite of the first bottom section;
the first bottom opening being delineated by the first bottom section;
the first top opening being delineated by the first spout section;
the first bottom opening and the first top opening being in fluid communication with the each other through the first bottom section, the at least one first middle section, and the first spout section;
the collector lip being internally positioned with the first bottom section;
the collector lip being angularly connected within the first bottom section;
the collection port traversing into the collector lip through the first bottom section;
the collector lip being in fluid communication a first collection vessel through the collection port;
the central opening traversing through the collector lip;
the first condenser unit being hermetically connected atop the boiler;
a first end of the connector tube being hermetically connected with the first spout section;
a second end of the connector tube being hermetically connected with the at least one second middle section of the second condenser unit;
the exhaust chimney being hermetically connected atop the second condenser unit; and
the boiler being in fluid communication with the exhaust chimney through the first condenser unit, the connector tube, and the second condenser unit.

16. The water distiller apparatus as claimed in claim 15 comprises:
the boiler comprises a base, a lateral wall, a brim, and a container opening;
the lateral wall being perimetrically connected around the base;
the brim being perimetrically positioned around the lateral wall, opposite of the base; and
the container opening being delineated by the brim, the lateral wall, and the base.

17. The water distiller apparatus as claimed in claim 15 comprises:
the at least one first middle section being perimetrically connected with the first bottom section;
the first spout section being perimetrically connected with the at least one first middle section, opposite of the first bottom section;
the first bottom opening being delineated by the first bottom section;
the first top opening being delineated by the first spout section;
the first bottom opening and the first top opening being in fluid communication with the each other through the first bottom section, the at least one first middle section, and the first spout section;
the collector lip being internally positioned with the first bottom section;
the collector lip being angularly connected within the first bottom section;
the collection port traversing into the collector lip through the first bottom section;
the collector lip being in fluid communication a first collection vessel through the collection port;
the collector lip comprises a central opening; and
the central opening traversing through the collector lip.

18. The water distiller apparatus as claimed in claim 15 comprises:
the at least one second middle section being perimetrically connected with the second bottom section;
the second spout section being perimetrically connected with the at least one second middle section, opposite of the second bottom section;
the second bottom opening being delineated by the second bottom section;
the second top opening being delineated by the second spout section; and
the second bottom opening and the second top opening being in fluid communication with the each other through the second bottom section, the at least one second middle section, and the second spout section.

19. The water distiller apparatus as claimed in claim 15 comprises:
the exhaust chimney comprises a vertical portion, a U-shaped portion, a horizontal portion, and a plurality of cooling fins;
the U-shaped portion being in fluid communication with the vertical portion;
the horizontal portion being in fluid communication with the U-shaped portion opposite of the vertical portion; and
the plurality of cooling fins being extended along the vertical portion.

20. The water distiller apparatus as claimed in claim 15 comprises:
a container opening of the boiler being in fluid communication with the first bottom opening;
the first top opening being in fluid communication with the first end of the connector tube;
the second end of the connector tube being in fluid communication with the at least one second middle section;
the second bottom opening being in fluid communication a second collection vessel; and
the second top opening being in fluid communication a vertical portion of exhaust chimney.
